(19) United States
(12) Patent Application Publication
(10) Pub. No.: US 2019/0171296 A1
(43) Pub. Date: Jun. 6, 2019

(54) GESTURE DETERMINATION APPARATUS AND PROGRAM

(71) Applicant: AISIN SEIKI KABUSHIKI KAISHA, Kariya-shi (JP)

(72) Inventors: Kosuke KITO, Chiryu-shi (JP); Takuro OSHIDA, Anjo-shi (JP); Osamu UNO, Kasuya-gun (JP); Satoshi MORI, Kasuya-gun (JP); Shingo FUJIMOTO, Tokai-shi (JP)

(73) Assignee: AISIN SEIKI KABUSHIKI KAISHA, Kariya-shi (JP)

(21) Appl. No.: 16/188,664

(22) Filed: Nov. 13, 2018

(30) Foreign Application Priority Data
Dec. 4, 2017 (JP) 2017-232907

(51) Int. Cl. G06F 3/01; G06K 9/00; G06T 7/20

(52) U.S. Cl. CPC G06F 3/017; G06K 9/00355; G06T 2207/30268; G06T 7/20; G06K 9/00832

(57) ABSTRACT

A gesture determination apparatus includes: a recognition device that recognizes a motion of an occupant and a first part and a second part of the occupant, based on a captured image captured by an imaging device that images an interior of a vehicle; and a determination device that determines whether or not a motion corresponding to any command is performed based on the motion of the occupant recognized by the recognition device and a positional relationship between the first part and the second part recognized by the recognition device.

### CROSS REFERENCE TO RELATED APPLICATIONS

This application is based on and claims priority under 35 U.S.C. §119 to Japanese Patent Application 2017-232907, filed on Dec. 4, 2017, the entire contents of which are incorporated herein by reference.

### TECHNICAL FIELD

This disclosure relates to a gesture determination apparatus and a program.

### BACKGROUND DISCUSSION

In the related art, a technology for detecting a gesture (motion) of an occupant riding in a vehicle and outputting a command corresponding to the detected gesture is known. For example, in JP 2015-219885A (Reference 1), a technology for extracting a first part and a second part of an occupant's hand from an image captured by a camera and deciding whether or not to output a command corresponding to a gesture corresponding to movement of the first part, according to a moving speed of the second part is disclosed.

However, in the related art described above, although it is possible to distinguish whether a recognized gesture is a gesture intended to input a command or another gesture, it is difficult to accurately determine whether or not the recognized gesture corresponds to a gesture defined in advance for any command. That is, it is difficult to accurately determine whether or not a gesture corresponding to any command is performed, which is problematic.

### SUMMARY

A gesture determination apparatus according to an aspect of this disclosure includes, for example, a recognition device that recognizes a motion of an occupant and a first part and a second part of the occupant, based on a captured image captured by an imaging device that images an interior of a vehicle, and a determination device that determines whether or not a motion corresponding to any command is performed based on the motion of the occupant recognized by the recognition device and a positional relationship between the first part and the second part recognized by the recognition device.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram illustrating a schematic configuration of an information processing system according to an embodiment;

FIG. 2 is a diagram illustrating an example of a hardware configuration of an image processing device;

FIG. 3 is a diagram illustrating an example of functions provided in the image processing device;

FIG. 4 is a view illustrating an example of skeleton information;

FIG. 5 is a table illustrating an example of correspondence information according to a first embodiment;

FIG. 6 is a view illustrating a motion of moving a palm of the right hand in an opening direction;

FIG. 7 is a view illustrating a positional relationship between a feature point corresponding to a thumb of the right hand of a driver and a feature point corresponding to a center point of the right hand of the driver;

FIG. 8 is a view illustrating a motion of moving the palm of the right hand in a closing direction;

FIG. 9 is a view illustrating a positional relationship between the feature point corresponding to the thumb of the right hand of the driver and the feature point corresponding to the center point of the right hand of the driver;

FIG. 10 is a view illustrating a motion of raising a held right hand of the driver;

FIG. 11 is a diagram illustrating a positional relationship between the feature point corresponding to the thumb of the right hand of the driver and the feature point corresponding to the center point of the right hand of the driver;

FIG. 12 is a flowchart illustrating an operation example of the image processing device according to this embodiment;

FIG. 13 is a table illustrating an example of correspondence information for an occupant in a front passenger seat;

FIG. 14 is a view illustrating a positional relationship between a feature point corresponding to a thumb of the left hand of an occupant in a front passenger seat and a feature point corresponding to a center point of the left hand of the occupant in the front passenger seat;

FIG. 15 is a view illustrating a positional relationship between the feature point corresponding to the thumb of the left hand of the occupant in the front passenger seat and the feature point corresponding to the center point of the left hand of the occupant in the front passenger seat;

FIG. 16 is a view illustrating a motion of hiding a face with the left hand of the occupant;

FIG. 17 is a view illustrating a positional relationship between a feature point corresponding to the head of the occupant and a feature point corresponding to the center point of the left hand of the occupant; and

FIG. 18 is a table illustrating an example of correspondence information according to a second embodiment.

### DETAILED DESCRIPTION

Hereinafter, embodiments of a gesture determination apparatus and a program disclosed here will be described in detail with reference to the accompanying drawings.

### First Embodiment

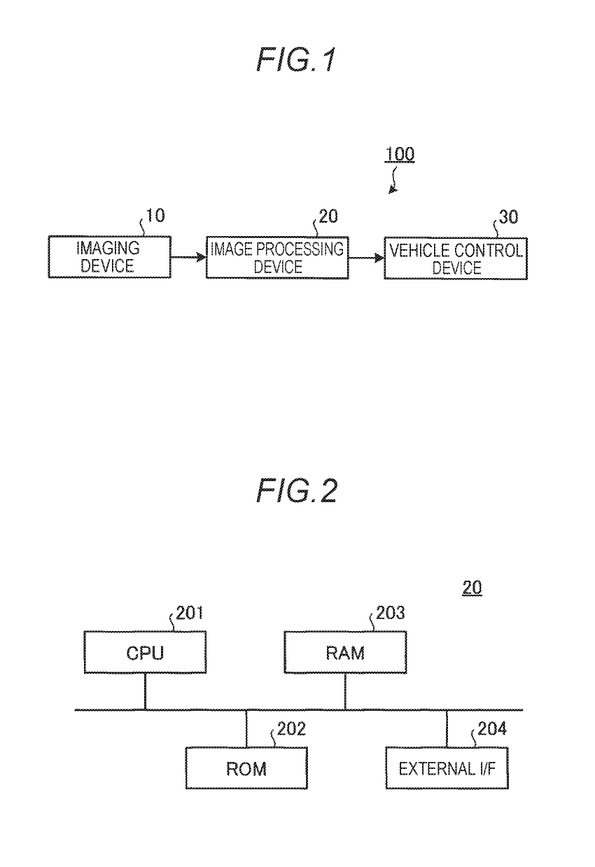

FIG. 1 is a diagram illustrating a schematic configuration of an information processing system 100 installed in a vehicle such as an automobile having a drive source such as an engine or a motor. As illustrated in FIG. 1, the information processing system 100 includes an imaging device 10, an image processing device 20, and a vehicle control device 30.

The imaging device 10 is an apparatus for imaging an interior of the vehicle. For example, the imaging device 10 is configured with a camera. In this example, the imaging device 10 continuously performs imaging at a predetermined frame rate. An image captured by the imaging device 10 (hereinafter, may be referred to as “captured image”) is input to the image processing device 20.

The image processing device 20 is an example of a “gesture determination apparatus”, and determines whether or not a motion corresponding to any command is performed based on a captured image input from the imaging device 10. In a case where the determination result is affirmative, the image processing device 20 outputs information (command information) indicating a command permitting output to the vehicle control device 30. A specific configuration of the image processing device 20 will be described later.

In this embodiment, description will be made on the assumption that a person who performs the motion corresponding to each command is a driver and the imaging device 10 is installed (a viewing angle and posture are adjusted) so that the upper body of the occupant (driver) in the driver's seat is imaged, but is not limited thereto. As will be described later, for example, a configuration in which an occupant in a front passenger seat or an occupant in a rear seat performs a motion corresponding to each command and the command is executed may be available. In this configuration, the imaging device 10 is installed not only to image the upper body of the driver, but also to image the upper body of the occupant in the front passenger seat and the passenger in the rear seat.

The vehicle control device 30 controls each constitutional unit of the vehicle according to a command indicated by command information input from the image processing device 20. Types of commands and the like will be described later together with a specific configuration of the image processing device 20.

Hereinafter, a specific configuration of the image processing device 20 of this embodiment will be described. FIG. 2 is a diagram illustrating an example of a hardware configuration of the image processing device 20. As illustrated in FIG. 2, the image processing device 20 includes a CPU 201, a ROM 202, a RAM 203, and an external I/F 204. In this example, the image processing device 20 has the same hardware configuration as a normal computer. Hardware elements of the image processing device 20 are not limited to hardware elements illustrated in FIG. 2, and a configuration in which other hardware elements are additionally provided may be adopted.

The CPU 201 executes a program to comprehensively control the operation of the image processing device 20 and realize various functions of the image processing device 20. Various functions of the image processing device 20 will be described later.

The ROM 202 is a nonvolatile memory, and stores various data including a program for activating the image processing device 20. The RAM 203 is a volatile memory including a work area for the CPU 201.

The external I/F 204 is an interface for connecting with an external apparatus. For example, as the external I/F 204, an interface for connecting with the imaging device 10 and an interface for connecting with the vehicle control device 30 are provided.

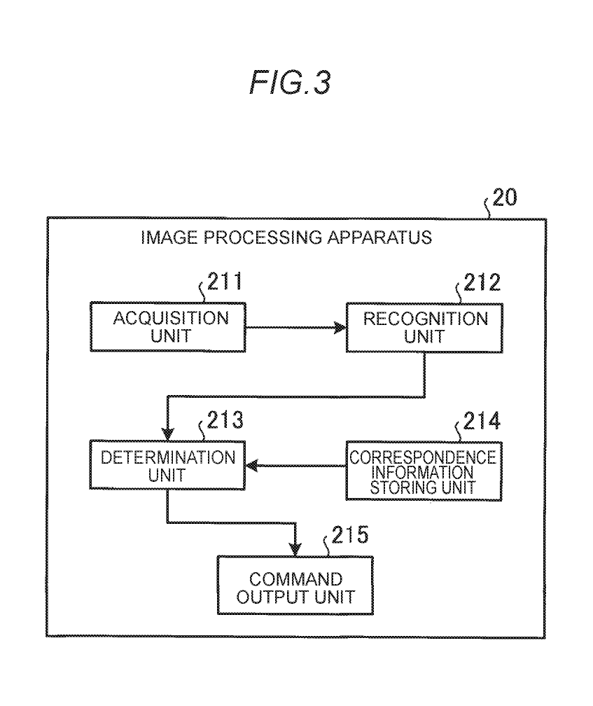

FIG. 3 is a diagram illustrating an example of functions included in the image processing device 20. In the example of FIG. 3, only the functions related to this disclosure are illustrated, but the functions of the image processing device 20 are not limited thereto.

As illustrated in FIG. 3, the image processing device 20 includes an acquisition unit 211, a recognition unit 212, a determination unit 213, a correspondence information storing unit 214, and a command output unit 215. In this example, the CPU 201 executes a program stored in a storage device such as the ROM 202, so that respective functions of the acquisition unit 211, the recognition unit 212, the determination unit 213, and the command output unit 215 are realized. However, this disclosure is not limited thereto and may have a configuration in which at least a portion of the acquisition unit 211, the recognition unit 212, the determination unit 213, and the command output unit 215 is configured with a dedicated hardware circuit. Further, the correspondence information storing unit 214 may be configured with, for example, the ROM 202 or the like and may be provided outside the image processing device 20.

The acquisition unit 211 acquires a captured image from the imaging device 10. Every time the imaging device 10 performs imaging, the acquisition unit 211 acquires a captured image obtained by the imaging.

The recognition unit 212 recognizes the motion of the occupant and the first part and second part of the occupant based on the captured image (captured image captured by the imaging device 10) acquired by the acquisition unit 211. In this example, the motion of the occupant is a motion using a hand, and each of the first part and the second part is a part included in the hand of the occupant. Furthermore, the first part is the thumb and the second part is the center point of the hand, but not limited thereto.

Various known technologies can be used as a method for recognizing the motion of the occupant and the first part and the second part based on the captured image. For example, a configuration in which the technology disclosed in JP 2017-182748 is utilized may be available. In this embodiment, the recognition unit 212 extracts a joint (feature point) of each part of the body (upper body) of the occupant reflected in the captured image and generates skeleton information (skeleton data). Then, based on the generated skeleton information, the recognition unit 212 recognizes the motion of the occupant and the first part and second part of the occupant.

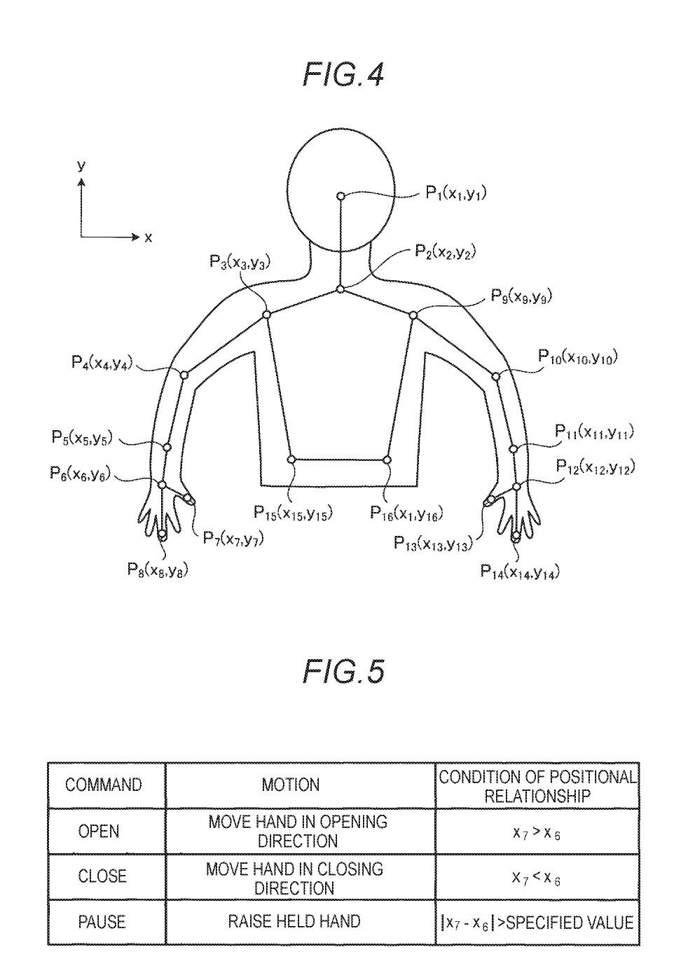

FIG. 4 is a diagram illustrating an example of skeleton information according to this embodiment. Each feature point is represented by a combination (two-dimensional coordinate information) of a value of the coordinate in the x-direction (horizontal direction) and a value of the coordinate in the y-direction (vertical direction). In the example of FIG. 4, as feature points of skeleton information, a feature point P1 (x1, y1) corresponding to the head, a feature points P2 (x2, y2) corresponding to the neck, a feature point P3 (x3, y3) corresponding to the right shoulder, a feature point P4 (x4, y4) corresponding to the right elbow, a feature point P5 (x5, y5) corresponding to the right wrist, a feature point P6 (x6, y6) corresponding to the center point of the right hand, a feature point P7 (x7, y7) corresponding to the thumb of the right hand, a feature point P8 (x8, y8) corresponding to the middle finger of the right hand, a feature point P9 (x9, y9) corresponding to the left shoulder, a feature points P10 (x10, y10) corresponding to the left elbow, a feature point P11 (x11, y11) corresponding to the left wrist, a feature point P12 (x12, y12) corresponding to the center point of the left hand, a feature points P13 (x13, y13) corresponding to the thumb of the left hand, a feature point P14 (x14, y14) corresponding to the middle finger of the left hand, a feature points P15 (x15, y15) corresponding to the right waist, and a feature point P16 (x16, y16) corresponding to the left waist are included, but are not limited thereto.

Here, it is assumed that the driver performs a motion using the right hand as a motion corresponding to each command, and the feature point P7 (x7, y7) corresponding to the thumb of the right hand is specified as the first part and the feature point P6 (x6, y6) corresponding to the center point of the right hand is specified as the second part. However, this disclosure is not limited thereto. For example, a configuration in which the driver performs a motion using the left hand as the motion corresponding to each command may also be available.

Returning to FIG. 3, description will be continued. The determination unit 213 determines whether or not a motion corresponding to any command is performed based on the motion of the occupant recognized by the recognition unit 212 and a positional relationship between the first part and the second part recognized by the recognition unit 212. In this embodiment, based on correspondence information in which a motion is associated with a positional relationship (a positional relationship between the first part and the second part) for each of a plurality of types of commands, the determination unit 213 determines whether or not a corresponding motion is performed. More specifically, the determination unit 213 refers to the correspondence information to specify a condition of the positional relationship associated with a motion that coincides with the motion of the occupant recognized by the recognition unit 212 and determines that the motion corresponding to the command associated with a combination of the motion and the condition is performed in a case where the positional relationship between the first part and the second part recognized by the recognition unit 212 satisfies the condition.

FIG. 5 is a table illustrating an example of correspondence information. In this example, the correspondence information is stored in the correspondence information storing unit 214. In the example of FIG. 5, a command relating to control of a sunroof is exemplified, but the type of the command is not limited thereto.

In FIG. 5, the command denoted as “OPEN” is a command instructing to open the sunroof, the command denoted as “CLOSE” is a command instructing to close the sunroof, and the command denoted as “PAUSE” is a command instructing to stop (pause) the opening and closing operation of the sunroof.

As illustrated in FIG. 5, for the command “OPEN”, a motion indicating that the hand is moved in the opening direction of the sunroof and the condition of the positional relationship indicating that a value x7 of the x-coordinate of the feature point P7 corresponding to the thumb of the right hand which is the first part is larger than a value x6 of the x-coordinate of the feature point P6 corresponding to the center point of the right hand which is the second part are associated with each other.

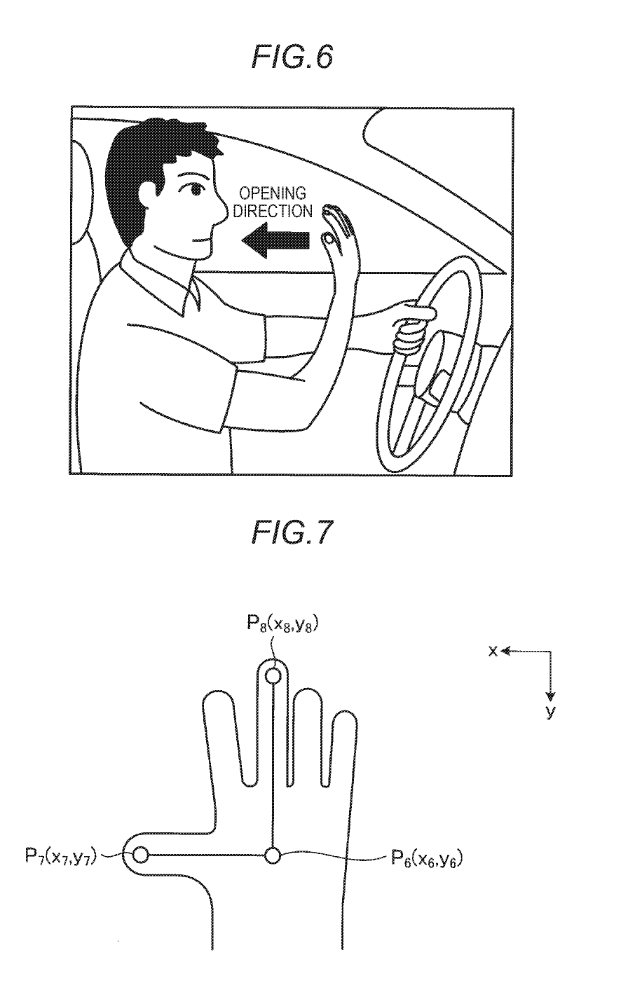

Here, as a motion defined in advance for the command “OPEN”, as illustrated in FIG. 6, a motion of moving the palm of the right hand in the opening direction of the sunroof is assumed. Here, it is assumed that the imaging device 10 is arranged so as to image the front of the driver, and in skeleton information based on the captured image when this motion is performed, the positional relationship between the feature point P7 corresponding to the thumb of the right hand of the driver and the feature point P6 corresponding to the center point of the right hand of the driver is as illustrated in FIG. 7 (the upper right is the origin, but is not limited thereto). In this example, since the left direction in FIG. 7 is the positive direction in the x-direction, the value x7 of the x-coordinate of the feature point P7 is larger than the value x6 of the x-coordinate of the feature point P6. Accordingly, in a case where it is indicated that the motion of moving the hand in the opening direction is recognized and the value x7 of the x-coordinate of the feature point P7 corresponding to the thumb of the right hand is larger than the value x6 of the x-coordinate of the feature point P6 corresponding to the center point of the right hand, it can be determined that the motion corresponding to the command “OPEN” is performed. The condition of the positional relation can also be regarded as a condition for accurately determining whether or not the recognized motion is a motion corresponding to the command.

As illustrated in FIG. 5, for the command “CLOSE”, a motion indicating that the hand is moved in the closing direction of the sunroof and a condition of the positional relationship indicating that the value x7 of the x-coordinate of the feature point P7 corresponding to the thumb of the right hand is smaller than the value x6 of the x-coordinate of the feature point P6 corresponding to the center point of the right hand are associated with each other.

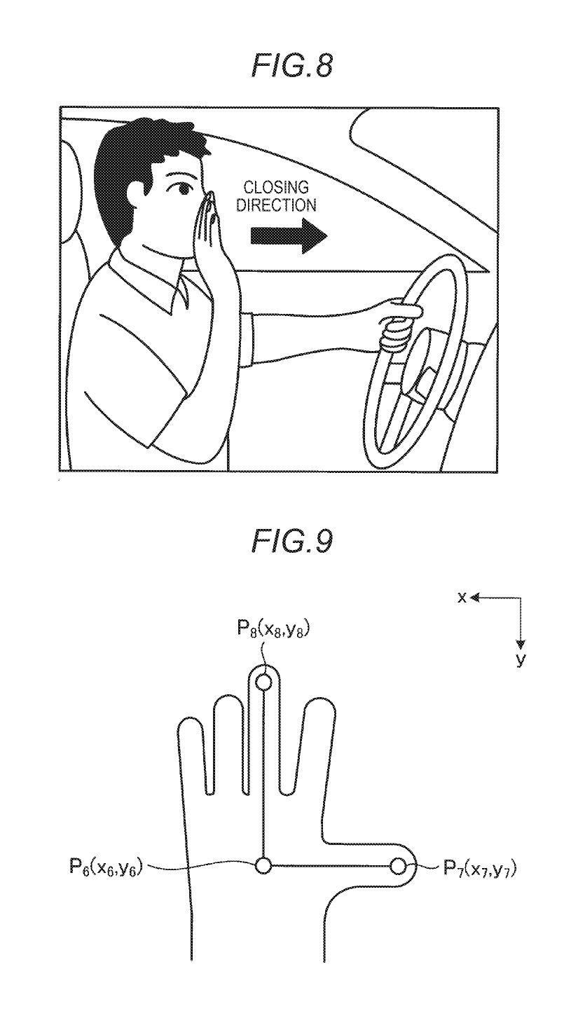

Here, as a motion defined in advance for the command “CLOSE”, as illustrated in FIG. 8, a motion of moving the palm of the right hand in the closing direction is assumed. The positional relationship between the feature point P7 corresponding to the thumb of the right hand of the driver and the feature point P6 corresponding to the center point of the right hand of the driver when this motion is performed is as illustrated in FIG. 9. Here, since the left direction in FIG. 9 is the positive direction in the x-direction, the value x7 of the x-coordinate of the feature point P7 illustrates a value smaller than the value x6 of the x-coordinate of the feature point P6. Accordingly, in a case where it is indicated that the motion of moving the hand in the closing direction is recognized and the value x7 of the x-coordinate of the feature point P7 corresponding to the thumb of the right hand is smaller than the value x6 of the x-coordinate of the feature point P6 corresponding to the center point of the right hand, it can be determined that the motion corresponding to the command “CLOSE” is performed.

As illustrated in FIG. 5, for the command “PAUSE”, a motion indicating raising a held hand and the condition of the positional relationship indicating that an absolute value of a difference between the value x7 of the x-coordinate of the feature point P7 corresponding to the thumb of the right hand and the value x6 of the x-coordinate of the feature point P6 corresponding to the center point of the right hand is larger than a specified value are associated with each other.

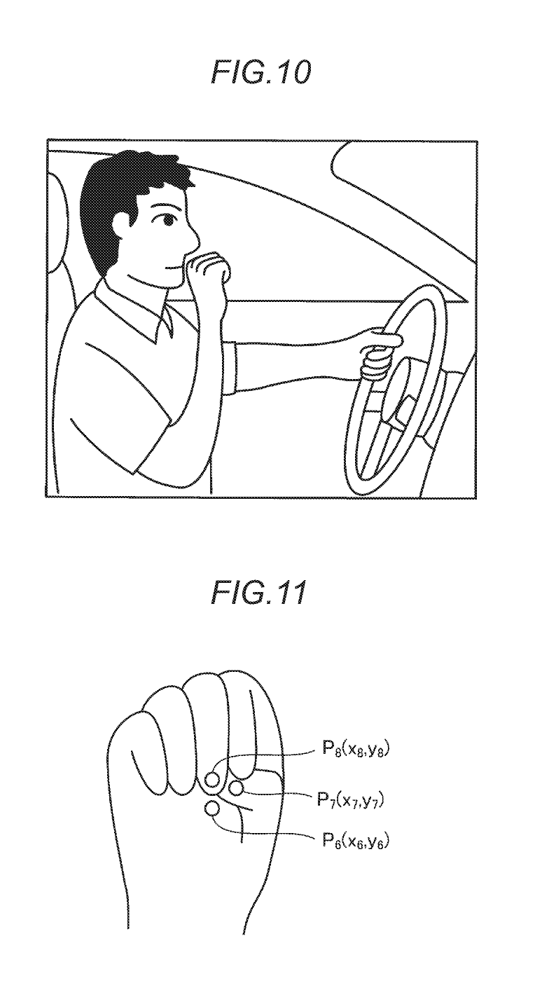

Here, as illustrated in FIG. 10, a motion of raising the held right hand is assumed as a motion defined in advance for the command “PAUSE”. The positional relationship between the feature point P7 corresponding to the thumb of the right hand of the driver and the feature point P6 corresponding to the center point of the right hand of the driver when this motion is performed is as illustrated in FIG. 11. When the right hand is held, the feature point P7 corresponding to the thumb and the feature point P6 corresponding to the center point are densely gathered at a position close to each other and thus, in a case where the absolute value of the difference between the value x7 of the x-coordinate of the feature point P7 corresponding to the thumb of the right hand and the value x6 of the x-coordinate value x6 of the feature point P6 corresponding to the center point of the right hand is larger than the specified value, it can be determined that the right hand is held. Accordingly, in a case where it is indicated that the motion of raising the hand is recognized and the absolute value of the difference between the value x7 of the x-coordinate of the feature point P7 corresponding to the thumb of the right hand and the value x6 of the x-coordinate of the feature point P6 corresponding to the center point of the right hand is larger than the specified value, it can be determined that the motion corresponding to the command “PAUSE” is performed.

For example, a configuration in which determination is made by considering a feature point P8 corresponding to the middle finger of the right hand may be adopted. For example, when the motion of raising the hand is recognized, in a case where the absolute value of the difference between the value x7 of the x-coordinate of the feature point P7 corresponding to the thumb of the right hand and the value x6 of the x-coordinate of the feature point P6 corresponding to the center point of the right hand is larger than the specified value and in a case where each of the absolute values of the difference between the value x8 of the x-coordinate of the feature point P8 corresponding to the middle finger of the right hand and the value (x7 or x6) of the x-coordinate of each of the feature point P7 and the feature point P6 is larger than the specified value, it can be determined that the held right hand is raised.

As described above, the determination unit 213 determines whether or not a motion corresponding to any command is performed, and inputs the determination result to the command output unit 215.

The command output unit 215 illustrated in FIG. 3 outputs the command information indicating the command determined that the corresponding motion is performed to the vehicle control device 30.

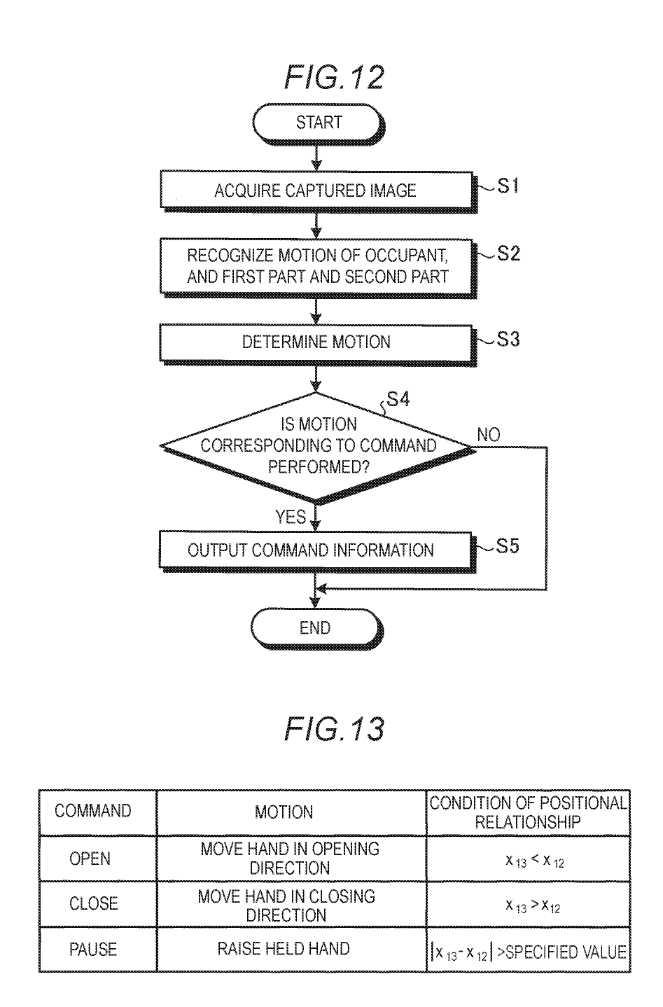

FIG. 12 is a flowchart illustrating an operation example of the image processing device 20 according to this embodiment. Since a specific content of each step is as described above, detailed description will be appropriately omitted.

As illustrated in FIG. 12, the acquisition unit 211 acquires a captured image from the imaging device 10 (Step 51). Next, based on the captured image acquired in Step 51, the recognition unit 212 recognizes the motion of the occupant (driver in this example) and the first part (thumb of the right hand in this example) and the second part (center point of the right hand in this example) (Step S2). Next, based on the motion of the occupant recognized in Step S2 and the positional relationship between the first part and the second part recognized in Step S2, the determination unit 213 determines whether or not the motion corresponding to any command is performed (Step S3).

In a case where it is determined, by the determination in Step S3, that the motion corresponding to any command is performed (Yes in Step S4), the command output unit 215 outputs command information indicating the command to the vehicle control device 30 (Step S5). In a case where it is determined, by the determination in Step S3, that the motion corresponding to any command is not performed (No in Step S4), the command information is not output, and processing at Step S1 and subsequent steps are repeated.

As described above, in this embodiment, in addition to the motion of the occupant recognized based on the captured image, it is possible to accurately determine whether or not the motion corresponding to any command is performed by considering the positional relationship between the first part and the second part of the occupant recognized based on the captured image.

For example, when an occupant performs a motion of “moving an open hand”, it is possible to accurately distinguish whether the open hand is moved in the forward direction or the backward direction by considering the positional relationship between the two points (the thumb, the center point, and the like) of the hand of the occupant. That is, this embodiment is particularly effective in the case where different commands are set depending on whether the open hand is moved in the forward direction or the backward direction (for example, it is possible to accurately determine whether or not a motion corresponding to each command is performed).

### Modification Example 1 of First Embodiment

For example, a configuration in which the correspondence information described above may be set for each of a plurality of occupants corresponding one-to-one with a plurality of seats may be available. For example, a configuration in which the correspondence information for the occupant in the driver's seat, the correspondence information for the occupant in the front passenger seat, and the correspondence information for the occupant in the rear seat are individually set may be available. Hereinafter, as one example, the correspondence information for the occupant in the front passenger seat will be described.

Here, it is assumed that the occupant in the front passenger seat performs a motion using the left hand as a motion corresponding to each command, and a feature point P13 (x13, y13) corresponding to the thumb of the left hand is specified as the first part and a feature point P12 (x12, y12) corresponding to the center point of the left hand is specified as the second part. However, this disclosure is not limited thereto. For example, a configuration in which the driver is assumed to perform a motion using the right hand as the motion corresponding to each command may be available.

FIG. 13 is a table illustrating an example of correspondence information for the occupant in the front passenger seat, and as in the first embodiment described above, the motion and the condition of the positional relationship are associated with each other for each of a plurality of commands relating to sunroof control. As illustrated in FIG. 13, for the command “OPEN”, a motion indicating that the hand is moved in the opening direction of the sunroof and a condition of the positional relationship indicating that the value x13 of the x-coordinate of the feature point P13 corresponding to the thumb of the left hand which is the first part is smaller than the value x12 of the x-coordinate of the feature point P12 corresponding to the center point of the left hand which is the second part are associated with each other.

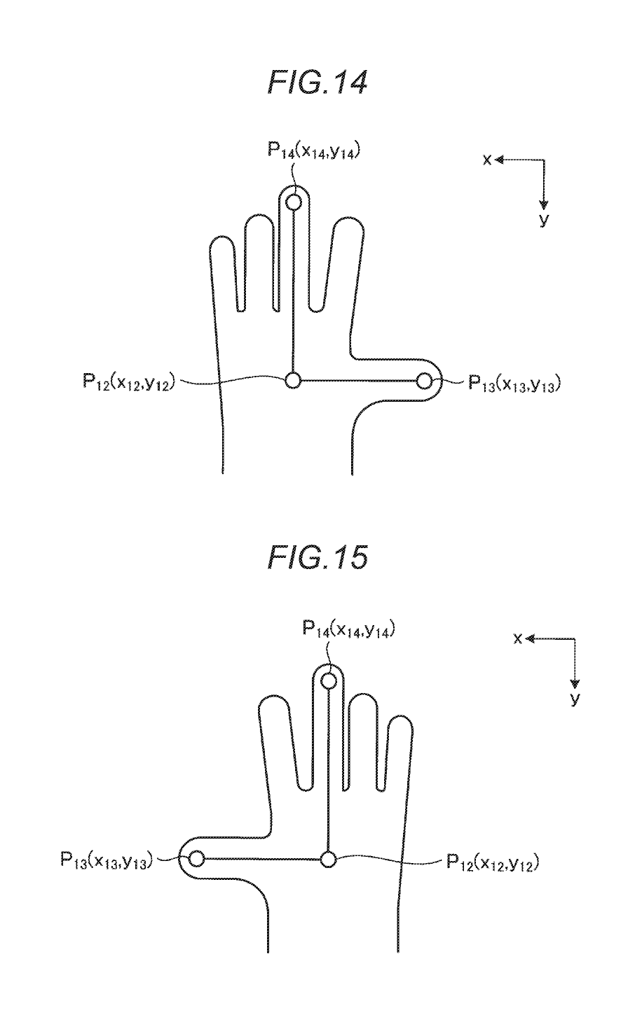

Here, as the motion (motion of the occupant in the front passenger seat) defined in advance for the command “OPEN”, a motion of moving the palm of the left hand in the opening direction is assumed. Here, it is assumed that the imaging device 10 is arranged so as to image the front of the occupant in the front passenger seat, and in skeleton information based on the captured image when this motion is performed, the positional relationship between the feature point P13 corresponding to the thumb of the left hand of the occupant in the front passenger seat and the feature point P12 corresponding to the center point of the left hand of the occupant in the front passenger seat is as illustrated in FIG. 14 (the upper right is the origin, but is not limited thereto). In this example, since the left direction in FIG. 14 is the positive direction in the x-direction, the value x13 of the x-coordinate of the feature point P13 is smaller than the value x12 of the x-coordinate of the feature point P12. Accordingly, for the occupant in the front passenger seat reflected in the captured image, in the case where it is indicated that the motion of moving the hand in the opening direction is recognized and the value x13 of the x-coordinate of the feature point P13 corresponding to the thumb of the left hand is smaller than the x-coordinate value x12 of the corresponding feature point P12 corresponding to the center point of the left hand, it can be determined that the motion corresponding to the command “OPEN” is performed.

As illustrated in FIG. 13, for the command “CLOSE”, a motion indicating that the hand is moved in the closing direction of the sunroof and a condition of the positional relationship indicating that the value x13 of the x-coordinate of the feature point P13 corresponding to the thumb of the left hand is larger than the value x12 of the x-coordinate of the feature point P12 corresponding to the center point of the left hand are associated with each other.

Here, as a motion defined in advance for the command “CLOSE”, a motion of moving the palm of the left hand in the closing direction is assumed. The positional relationship between the feature point P13 corresponding to the thumb of the left hand of the occupant in the front passenger seat and the feature point P12 corresponding to the center point of the left hand of the occupant in the front passenger seat when this motion is performed is as illustrated in FIG. 15. In this example, since the left direction in FIG. 15 is the positive direction in the x-direction, it is indicated that the value x13 of the x-coordinate of the feature point P13 is larger than the value x12 of the x-coordinate of the feature point P12. Accordingly, for the occupant in the front passenger seat reflected in the captured image, in a case where it is indicated that the motion of moving the hand in the closing direction is recognized and the value x13 of the x-coordinate of the feature point P13 corresponding to the thumb of the left hand is larger than the value x12 of the x-coordinate of the feature point P12 corresponding to the center point of the left hand, it can be determined that the motion corresponding to the command “CLOSE” is performed.

As illustrated in FIG. 13, for the command “PAUSE”, a motion indicating raising the held hand and the condition of the positional relationship indicating that an absolute value of a difference between the value x13 of the x-coordinate of the feature point P13 corresponding to the thumb of the left hand and the value x12 of the x-coordinate of the feature point P12 corresponding to the center point of the left hand is larger than a specified value are associated with each other. Since this is the same as the content described in the correspondence information for the driver, detailed description will be omitted.

The correspondence information for the occupant in the rear seat can also be individually set in the same manner as described above.

### Modification Example 2 of First Embodiment

In the embodiment described above, a command relating to control of the sunroof is exemplified, but the type of command is not limited thereto. For example, a command relating to opening and closing control of a window regulator, a command relating to sound volume control of audio equipment, a command relating to transmittance control of a windshield glass, and the like may be available. The motion defined in advance for each command can also be set. For example, for the command relating to sound volume control of audio equipment, a motion of rotating a finger or the like may be defined in advance.

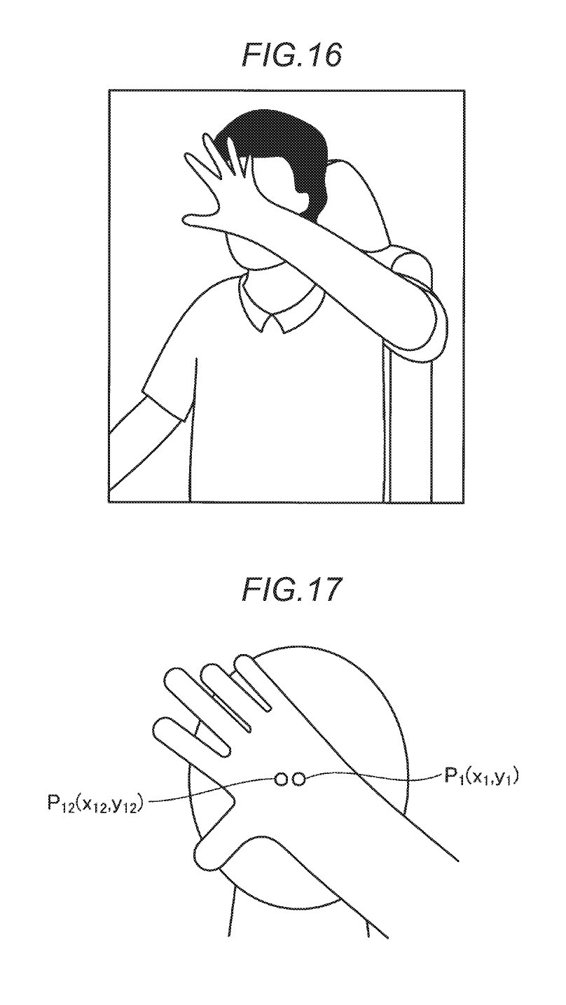

Further, for example, for a command instructing to change transmittance of a car window glass from first transmittance corresponding to a transparent state to second transmittance corresponding to a light blocked state, as illustrated in FIG. 16, a motion of hiding the face with the left hand (or right hand) of the occupant may be defined in advance. The positional relationship between the feature point P1 corresponding to the head of the occupant and the feature point P12 corresponding to the center point of the left hand of the occupant when this motion is performed is as illustrated in FIG. 17. For convenience of description, illustration of other feature points is omitted. When the face is hidden with the left hand, the feature point P1 corresponding to the head and the feature point P12 corresponding to the center point of the left hand are densely gathered at a position close to each other and thus, in a case where the absolute value of the difference between the value x1 of the x-coordinate of the feature point P1 corresponding to the head and the value x12 of the x-coordinate of the feature point P12 corresponding to the center point of the left hand is larger than the specified value, it can be determined that the face is hidden with the left hand.

In this example, the condition indicating that the absolute value of the difference between the value x1 of the x-coordinate of the feature point P1 corresponding to the head and the value x12 of the x-coordinate of the feature point P12 corresponding to the center point of the left hand is larger than the specified value is set, but this disclosure is not limited thereto, and the condition of the positional relationship can be randomly set. For example, as the condition of the positional relationship, a configuration in which the condition indicating that the feature point P12 corresponding to the center point of the left hand of the occupant and the feature point P13 corresponding to the thumb (which may be the middle finger) of the left hand of the occupant exist in a predetermined area (for example, an area where a face is assumed to be reflected) is set may be available.

### Modification Example 3 of First Embodiment

For example, a configuration in which the determination unit 213 described above and the command output unit 215 described above is mounted on the vehicle control device 30 side may be available. In this case, a combination of the image processing device 20 and the vehicle control device 30 corresponds to the “gesture determination apparatus”. In short, the gesture determination apparatus only needs to have a configuration in which at least the recognition unit 212 and the determination unit 213 described above are included, and may be configured with a single apparatus or a plurality of apparatuses (configuration in which the recognition unit 212 and the determination unit 213 are distributed to a plurality of apparatuses).

### Modification Example 4 of First Embodiment

For example, the command output unit 215 may have a configuration in which any command is not output in a case where it is determined that the operation corresponding to another command is performed within a certain time after it is determined by the determination unit 213 that the motion corresponding to any command is performed. For example, the command output unit 215 may be configured not to output any command in a case where a determination result indicating that the motion corresponding to the “CLOSE” command is performed is received within a predetermined time after receiving the determination result indicating that the motion corresponding to the “OPEN” command is performed from the determination unit 213. The predetermined time can be randomly set.

### Modification Example 5 of First Embodiment

Also, for example, the command output unit 215 may be configured to stop a command which is output being executed in a case where it determined, by the determination unit 213, that the motion corresponding to another command is performed during execution of the output command. For example, the command output unit 215 may be configured to request the vehicle control device 30 to pause execution of the “OPEN” command in a case where the determination result indicating that the motion corresponding to the “CLOSE” command is performed is received during execution of the output “OPEN” command from the determination unit 213. Upon receiving this request, the vehicle control device 30 can pause execution of the “OPEN” command (pause sunroof opening operation).

### Second Embodiment

Next, a second embodiment will be described. Descriptions of portions common to those of the first embodiment described above will be appropriately omitted. In this embodiment, the recognition unit 212 recognizes the motion of the occupant and a reference part indicating one part serving as a reference of an occupant, based on the captured image captured by the imaging device 10 which images an interior of the vehicle. This recognition method is the same as the recognition method described in the first embodiment described above. Then, based on the motion of the occupant recognized by the recognition unit 212 and the position of the reference part recognized by the recognition unit 212, the determination unit 213 determines whether or not a motion corresponding to any command is performed. Since other configurations are the same as those of the first embodiment, description of the common portions will be appropriately omitted.

For example, the motion of the occupant is a motion using a hand, and the reference part may be a part included in the hand of the occupant. For example, the reference part may be the center point of the hand of the occupant, but is not limited thereto.

The determination unit 213 of this embodiment determines whether or not a motion corresponding to any command is performed, based on the correspondence information that associates a motion with a condition (range) of the position of the reference part for each of a plurality of types of commands. More specifically, the determination unit 213 refers to the correspondence information to specify a condition of a position of the reference part associated with the motion that coincides with the motion of the occupant recognized by the recognition unit 212 and determines that the motion corresponding to the command associated with a combination of the motion and the condition is performed in a case where the position of the reference part recognized by the recognition unit 212 satisfies the condition.

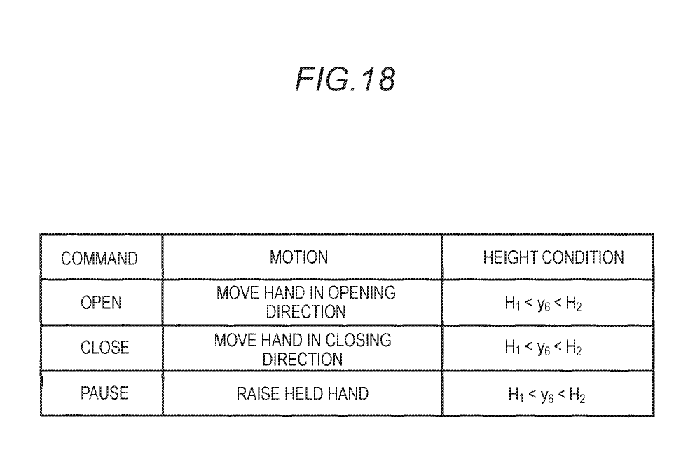

FIG. 18 is a table illustrating an example of the correspondence information. In the example of FIG. 18, a command relating to control of the sunroof is exemplified, but the type of command is not limited thereto. As illustrated in FIG. 18, for each of a plurality of commands, a motion and a range of heights serving as a condition of the height of the reference part (an example of a “condition of the position of the reference part”) are associated with each other. In this example, the reference part is the center point of the right hand of the occupant, and a condition indicating that a value y6 of the y-coordinate of the feature point P6 corresponding to the center point of the right hand is larger than a first threshold value H1 and a condition indicating that the value y6 is smaller than a second threshold value H2 (>H1) are associated with each other, as the condition of the height. Here, the conditions of height associated with respective commands are all the same, but this disclosure is not limited thereto, and different conditions can be individually set for each command, for example.

For example, when attention is paid to the command “OPEN”, in a case where the motion of moving the hand in the opening direction of the sunroof is recognized, and the value y6 of the y-coordinate of the feature point P6 corresponding to the center point of the right hand, which is the reference part, is larger than the first threshold value H1 and is smaller than the second threshold value H2, the determination unit 213 can determine that the motion corresponding to the command “OPEN” is performed. That is, output of the command “OPEN” can be permitted. Similarly to the condition of the positional relationship described in the first embodiment, the condition of the height of the reference part can be regarded as a condition for accurately determining whether or not the recognized motion is a motion corresponding to the command.

As described above, in this embodiment, it is possible to accurately determine whether or not the motion corresponding to any command is performed by considering the position (height in this example) of the reference part of the occupant (the center point of the right hand of the occupant in this example) recognized based on the captured image, in addition to the motion of the occupant recognized based on the captured image. For example, even if the occupant performs any motion outside a height range in which the occupant is assumed to perform the motion corresponding to the command, the operation is rejected as a motion unrelated to the motion corresponding to the command and thus, no command is issued. That is, it is possible to prevent issuance of a command due to an inappropriate motion.

Here, the case where the condition of the position (height) in the vertical direction of the reference part is set as the condition of the position of the reference part has been described as an example, but this disclosure is not limited thereto. For example, a configuration in which the condition of the position of the reference part in the horizontal direction is set may be available. In short, as the condition of the position of the reference part, a configuration in which a condition is set with which it can be determined whether or not the reference part exists within the range of an area (gesture area) in which it is assumed that the motion corresponding to the command is to be performed may be available.

A gesture determination apparatus according to an aspect of this disclosure includes, for example, a recognition device that recognizes a motion of an occupant and a first part and a second part of the occupant, based on a captured image captured by an imaging device that images an interior of a vehicle, and a determination device that determines whether or not a motion corresponding to any command is performed based on the motion of the occupant recognized by the recognition device and a positional relationship between the first part and the second part recognized by the recognition device. According to this configuration, it is possible to accurately determine whether or not the motion corresponding to any command is performed by considering the positional relationship between the first part and the second part of the occupant recognized based on the captured image, in addition to the motion of the occupant recognized based on the captured image.

In the gesture determination apparatus according to the aspect of this disclosure, for example, the determination device may determine whether or not a motion corresponding to any command is performed based on correspondence information in which a motion is associated with a condition of the positional relationship for each of a plurality of types of commands. According to this configuration, the determination device can accurately determine whether or not the motion corresponding to any command is performed by using the correspondence information in which the motion is associated with the condition of the positional relation for each of the plurality of types of commands.

In the gesture determination apparatus according to the aspect of this disclosure, for example, the determination device may refer to the correspondence information to specify a condition of the positional relationship associated with a motion that coincides with the motion of the occupant recognized by the recognition device and determine that a motion corresponding to a command associated with a combination of the motion and the condition is performed in a case where the positional relationship between the first part and the second part recognized by the recognition device satisfies the condition. According to this configuration, it is possible to accurately determine whether or not the motion corresponding to any command is performed.

In the gesture determination apparatus according to the aspect of this disclosure, for example, the correspondence information may be set for each of a plurality of occupants corresponding one-to-one to a plurality of seats. According to this configuration, correspondence information can be set in advance for each of occupants in, for example, a driver's seat, a front passenger seat, and a rear seat. That is, for each command, it is possible to individually set a combination of a motion for each seat and a condition of the positional relationship.

In the gesture determination apparatus according to the aspect of this disclosure, for example, the motion of the occupant may be a motion using a hand, and each of the first part and the second part may be a part included in the hand of the occupant. According to this configuration, for example, based on the motion (motion using the hand) of the occupant recognized based on the captured image and the positional relationship between the first part and the second part in the hand of the occupant, it is possible to accurately determine whether or not the motion using the hand corresponding to any command is performed.

In the gesture determination apparatus according to the aspect of this disclosure, for example, the first part may be a thumb and the second part may be a center point of the hand. According to this configuration, for example, in a case where it is assumed that the motion corresponding to the command is a motion using the hand of the occupant, it is possible to accurately determine whether or not the motion using the hand corresponding to any command is performed, based on the motion (motion using the hand) of the occupant recognized based on the captured image and the positional relationship between the thumb (first part) of the hand and the center point (second part) of the hand of the occupant.

A gesture determination apparatus according to another aspect of this disclosure includes, for example, a recognition device that recognizes a motion of an occupant and a reference part indicating one part serving as a reference of the occupant, based on a captured image captured by an imaging device that images an interior of a vehicle, and a determination device that determines whether or not a motion corresponding to any command is performed, based on the motion of the occupant recognized by the recognition device and a position of the reference part recognized by the recognition device. According to this configuration, it is possible to accurately determine whether or not the motion corresponding to any command is performed by considering the position of the reference part of the occupant recognized based on the captured image, in addition to the motion of the occupant recognized based on the captured image.

A program according to another aspect of this disclosure causes a computer to execute, for example, a recognition step of recognizing a motion of an occupant and a first part and a second part of the occupant, based on a captured image captured by an imaging device that images an interior of a vehicle, and a determination step of determining whether or not a motion corresponding to any command is performed based on the motion of the occupant recognized in the recognition step and a positional relationship between the first part and the second part recognized in the recognition step. According to this configuration, it is possible to accurately determine whether or not the motion corresponding to any command is performed by considering the positional relationship between the first part and the second part of the occupant recognized based on the captured image, in addition to the motion of the occupant recognized based on the captured image.

Although the embodiments according to this disclosure have been described above, this disclosure is not limited to the embodiments described above as they are. In the implementation stage of this disclosure, constitutional elements can be modified and embodied within a range not departing from the gist of this disclosure. Further, various inventions can be formed by appropriately combining a plurality of constituent elements disclosed in the embodiments described above. For example, some constituent elements may be deleted from all the constituent elements illustrated in the embodiments. Further, each of the embodiments and modification examples described above can be randomly combined.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A gesture determination apparatus comprising:
a recognition device that recognizes a motion of an occupant and a first part and a second part of the occupant, based on a captured image captured by an imaging device that images an interior of a vehicle; and
a determination device that determines whether or not a motion corresponding to any command is performed based on the motion of the occupant recognized by the recognition device and a positional relationship between the first part and the second part recognized by the recognition device.

2. The gesture determination apparatus according to claim 1,
wherein the determination device determines whether or not a motion corresponding to any command is performed based on correspondence information in which a motion is associated with a condition of the positional relationship for each of a plurality of types of commands.

3. The gesture determination apparatus according to claim 2,
wherein the determination device refers to the correspondence information to specify a condition of the positional relationship associated with a motion that coincides with the motion of the occupant recognized by the recognition device and determines that a motion corresponding to a command associated with a combination of the motion and the condition is performed in a case where the positional relationship between the first part and the second part recognized by the recognition device satisfies the condition.

4. The gesture determination apparatus according to claim 2,
wherein the correspondence information is set for each of a plurality of occupants corresponding one-to-one to a plurality of seats.

5. The gesture determination apparatus according to claim 1,
wherein the motion of the occupant is a motion using a hand, and
each of the first part and the second part is a part included in the hand of the occupant.

6. The gesture determination apparatus according to claim 5,
wherein the first part is a thumb, and
the second part is a center point of the hand.

7. A gesture determination apparatus, comprising:
a recognition device that recognizes a motion of an occupant and a reference part indicating one part serving as a reference of the occupant, based on a captured image captured by an imaging device that images an interior of a vehicle; and
a determination device that determines whether or not a motion corresponding to any command is performed, based on the motion of the occupant recognized by the recognition device and a position of the reference part recognized by the recognition device.

8. A program for causing a computer to execute:
a recognition step of recognizing a motion of an occupant and a first part and a second part of the occupant, based on a captured image captured by an imaging device that images an interior of a vehicle; and
a determination step of determining whether or not a motion corresponding to any command is performed based on the motion of the occupant recognized in the recognition step and a positional relationship between the first part and the second part recognized in the recognition step.
